(19) United States
(12) Patent Application Publication
(10) Pub. No.: US 2025/0272696 A1
(43) Pub. Date: Aug. 28, 2025

(54) POINT MANAGEMENT SYSTEM, POINT MANAGEMENT METHOD, AND NON-TRANSITORY RECORDING MEDIUM

(71) Applicants: Erika Oshima, Kanagawa (JP); Tohru Morishima, Kanagawa (JP)

(72) Inventors: Erika Oshima, Kanagawa (JP); Tohru Morishima, Kanagawa (JP)

(73) Assignee: Ricoh Company, Ltd., Tokyo (JP)

(21) Appl. No.: 19/032,083

(22) Filed: Jan. 19, 2025

(30) Foreign Application Priority Data
Feb. 28, 2024 (JP) 2024-028746
Nov. 12, 2024 (JP) 2024-197301

(51) Int. Cl. G06Q 30/018; G06Q 10/04

(52) U.S. Cl. CPC G06Q 30/018; G06Q 10/04

(57) ABSTRACT

A point management system includes circuitry to issue first identification information identifying a point for a consumer to obtain a coupon, register the first identification information in first association information, and calculate an actual value of a carbon dioxide emission from an amount of activity for a printed material. The printed material bears a symbol including the first identification information. The circuitry calculates the number of points based on the actual value, and registers the calculated points in the first association information in association with the first identification information.

### CROSS-REFERENCE TO RELATED APPLICATIONS

This patent application is based on and claims priority pursuant to 35 U.S.C. § 119 (a) to Japanese Patent Application Nos. 2024-028746, filed on Feb. 28, 2024, and 2024-197301, filed on Nov. 12, 2024, in the Japan Patent Office, the entire disclosure of which is hereby incorporated by reference herein.

### BACKGROUND

### Technical Field

The present disclosure relates to a point management system, a point management method, and a non-transitory recording medium.

### Related Art

The butterfly mark of Japan Waterless Printing Association (WPA) is given to printed materials produced by environmentally friendly waterless printing that does not use moistening water.

On the carbon offset printed material produced by the members of Japan WPA, carbon dioxide (CO2) emissions in grams per copy calculated by Printing Goes Green, which is CO2 emission calculation software provided by Japan WPA, is indicated.

Further, there are techniques for measuring the consumption of printer resources and trading environmental offsets. For example, an automatic computer control system known in the art includes a printer resource search system for collecting data on consumed resources from a printer and controlling orders of environmental offset projects.

### SUMMARY

The present disclosure described herein provides a point management system that includes circuitry to issue first identification information identifying a point for a consumer to obtain a coupon, register the first identification information in first association information, and calculate an actual value of a carbon dioxide emission from an amount of activity for a printed material. The printed material bears a symbol including the first identification information. The circuitry calculates the number of points based on the actual value, and registers the calculated points in the first association information in association with the first identification information.

The present disclosure described herein provides a point management method that includes issuing first identification information identifying a point for a consumer to obtain a coupon, registering the first identification information in first association information, and calculating an actual value of a carbon dioxide emission from an amount of activity for a printed material. The printed material bears a symbol including the first identification information. The method further includes calculating the number of points based on the actual value, and registering the calculated number of points in the first association information in association with the first identification information.

The present disclosure described herein provides a non-transitory recording medium storing a plurality of program codes which, when executed by one or more processors, causes the one or more processors to perform a method that includes issuing first identification information identifying a point for a consumer to obtain a coupon, registering the first identification information in first association information, and calculating an actual value of a carbon dioxide emission from an amount of activity for a printed material. The printed material bears a symbol including the first identification information. The method further includes calculating the number of points based on the actual value, and registering the calculated number of points in the first association information in association with the first identification information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an information processing system;

FIG. 2 is a diagram illustrating an outline of an operation performed by the information processing system illustrated in FIG. 1;

FIG. 3 is a diagram illustrating parties involved in an eco-point management system included in the information processing system illustrated in FIG. 1 and an outline of operations thereof;

FIG. 4 is a block diagram illustrating a hardware configuration of the eco-point management system illustrated in FIG. 3;

FIG. 5 is a block diagram illustrating a hardware configuration of a consumer terminal;

FIG. 6 is a block diagram illustrating a hardware configuration of a printer;

FIG. 7 is a diagram illustrating a functional configuration of the information processing system illustrated in FIG. 1;

FIG. 8 is a diagram illustrating a structure of data processed by the information processing system illustrated in FIG. 7;

FIG. 9 is a sequence chart of a point registration process performed by the information processing system illustrated in FIG. 7;

FIG. 10 is a diagram illustrating changes in a point management database (DB) in the point registration process illustrated in FIG. 9;

FIG. 11 is a flowchart of a point obtaining process performed by the information processing system illustrated in FIG. 7;

FIG. 12 is a diagram illustrating changes in the point management DB in the point obtaining process illustrated in FIG. 11;

FIG. 13 is a diagram illustrating changes in the screen display on the consumer terminal in the point obtaining process illustrated in FIG. 11;

FIG. 14 is a flowchart of a coupon exchange process performed by the information processing system illustrated in FIG. 7; and

FIG. 15 is a diagram illustrating changes in the screen display of the consumer terminal in the coupon exchange process illustrated in FIG. 14.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, a point management system, a point management method, and a program for point management according to embodiments of the present disclosure are described below with reference to the accompanying drawings. As used herein, the singular forms “a,” “an,” and “the” are intended to include the plural forms as well, unless the context clearly indicates otherwise.

The present invention, however, is not limited to the following embodiments, and constituent elements of the following embodiments include elements conceivable by those skilled in the art, substantially the same elements, and elements within so-called equivalent ranges. Furthermore, various omissions, substitutions, changes, and combinations of the constituent elements may be made without departing from the gist of the following embodiments.

### Overall Configuration and Operation of Information Processing System

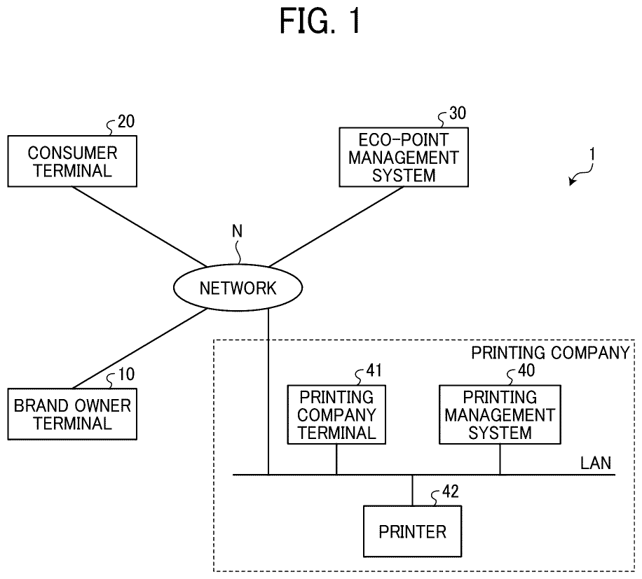

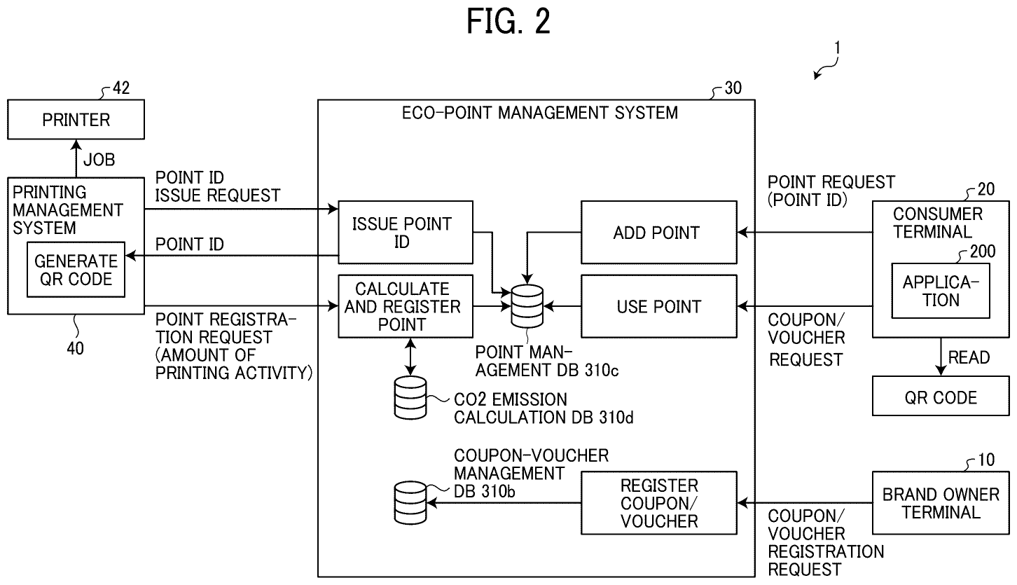

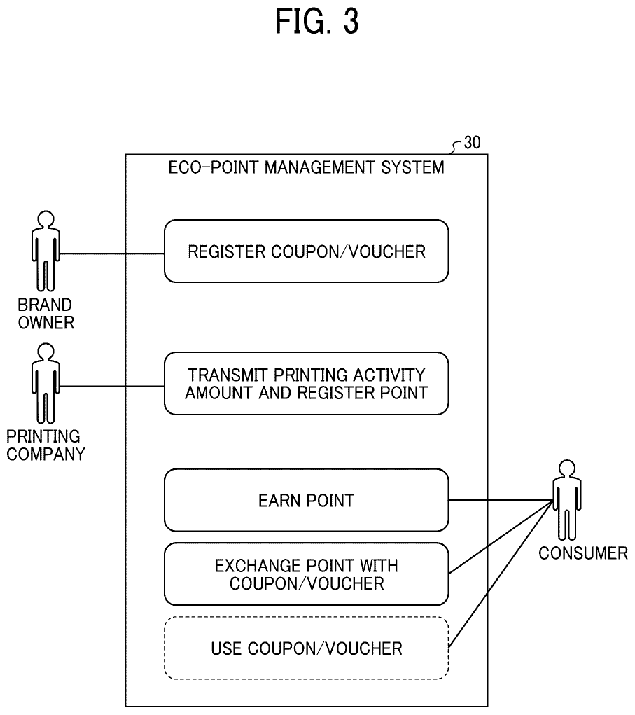

FIG. 1 is a diagram illustrating an overall configuration of an information processing system 1. FIG. 2 is a diagram illustrating an outline of an operation performed by the information processing system 1. FIG. 3 is a diagram illustrating parties involved in an eco-point management system 30 of the information processing system 1 and an outline of operations performed by the eco-point management system 30. A description is given of the overall configuration of the information processing system 1 with reference to FIGS. 1 to 3.

The information processing system 1 illustrated in FIG. 1 registers an eco-point based on the actual carbon dioxide emission generated in producing a printed material and enables a consumer of the product to use the eco-point. Eco-points are points given to a consumer who purchases an environmentally friendly product or service, and eco-points provide some benefit to the consumer when used. The eco-points may be referred to simply as points in the following description. As illustrated in FIG. 1, the information processing system 1 includes a brand owner terminal 10 (second information processing terminal), a consumer terminal 20 (first information processing terminal), an eco-point management system 30, a printing management system 40, a printing company terminal 41, and a printer 42. The printing management system 40, the printing company terminal 41, and the printer 42 are owned by a printing company. The brand owner terminal 10, the consumer terminal 20, the eco-point management system 30, and the printing management system 40 perform data communication via a network N. The printing management system 40, the printing company terminal 41, and the printer 42 owned by the printing company are connected to a local area network (LAN) to perform data communication.

The brand owner terminal 10 is an information processing terminal used by a brand owner. The brand owner is a company that receives a service provided by the eco-point management system 30, sells a printed material (product) bearing a symbol such as a QUICK RESPONSE (QR) CODE to consumers, and posts, on an app, coupons, vouchers, or both of coupons and vouchers (may be collectively referred to as coupons in the following description) for a product of the company, thereby encouraging the consumers to purchase new products. A coupon is a virtual ticket authorizing a consumer to purchase or exchange a product or service at a discount price and is a concept including the above-described voucher. The brand owner corresponds to a “provider.” As illustrated in FIGS. 2 and 3, the brand owner terminal 10 requests the eco-point management system 30 to register a coupon for a product of the brand owner. Then, the eco-point management system 30 registers the information on the coupon in a coupon-voucher management database (DB) 310b.

The consumer terminal 20 is an information processing terminal such as a personal computer (PC) used by a consumer who purchases a product provided by the brand owner. As illustrated in FIGS. 2 and 3, the consumer terminal 20 reads a two-dimensional code (QR CODE in the present embodiment) printed on a product purchased by a consumer in response to an operation of the consumer, and requests the eco-point management system 30 to obtain a point associated with the point identifier (ID) included in the QR CODE. The point ID is first identification information. The eco-point management system 30 adds the number of points associated with the point ID to the points owned by the consumer in association with the consumer in a point management DB 310c. The point management DB 310c is first association information. As illustrated in FIGS. 2 and 3, in response to an operation of the consumer, the consumer terminal 20 transmits to the eco-point management system 30 a request to obtain a coupon in exchange for the point earned (obtained) by the consumer. Then, the eco-point management system 30 registers the coupon as a coupon obtained by the consumer. Then, the consumer can use the obtained coupon via the consumer terminal 20.

Although the QR CODE is printed on the product in the description above, any symbol in which information is encoded or included may be used. Examples of the symbol include other two-dimensional codes such as Portable Data File (PDF) 417 or DataMatrix, binary codes, and one-dimensional codes such as barcodes. Alternatively, the symbol may be the combination of any of these codes. In the following description, the symbol in which a point ID is included or encoded is a QR CODE.

The eco-point management system 30 is an information processing apparatus or an information processing system that registers, in response to a request from a printing company, a point corresponding to the actual carbon dioxide emission generated in producing a printed material, and provides the service of allowing the consumer who purchases the printed material (product) to earn the point and exchange the point with a coupon registered by the brand owner.

The printing management system 40 is implemented by a server apparatus or a server system that manages execution of a printing process. As illustrated in FIGS. 2 and 3, the printing management system 40 requests, in response to an instruction from the printing company, the eco-point management system 30 to register a point ID, and requests the registration of the point corresponding to the actual carbon dioxide emission generated in the printing of the printed material by the printer 42. The eco-point management system 30 calculates the number of points by using the actual carbon dioxide emission and the emission intensity stored in a CO2 emission calculation DB 310d. The emission intensity indicates the carbon dioxide emission per unit of activity amount. The eco-point management system 30 registers the calculated number of points in the coupon-voucher management DB 310b. The activity amount indicates, for each process, the amount of activity or processing that generates carbon dioxide emission in printing. Examples of the activity amount include the electricity consumed by the printer 42, the toner and the number of sheets consumed in the printing, and the number of sheets discarded as waste sheets.

The printing company terminal 41 is an information processing terminal such as a PC for instructing execution of a job.

The printer 42 is an image forming apparatus that executes a job to perform printing in response to an instruction from the printing management system 40.

### Hardware Configuration of Eco-Point Management System

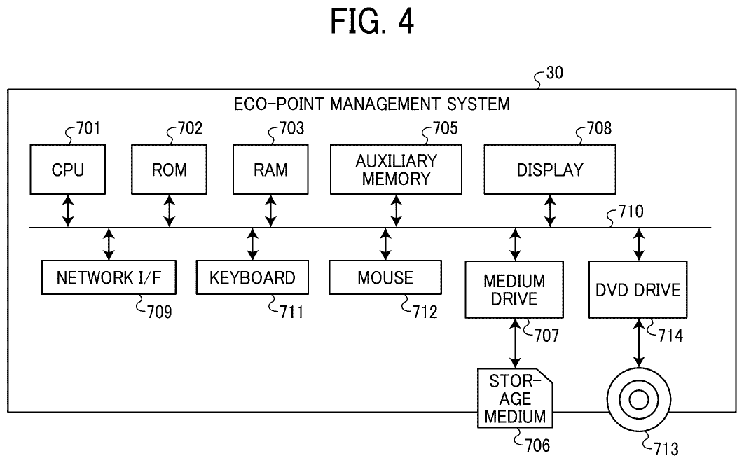

FIG. 4 is a block diagram illustrating a hardware configuration of the eco-point management system 30. A description is given below of the hardware configuration of the eco-point management system 30 with reference to FIG. 4.

As illustrated in FIG. 4, the eco-point management system 30 includes a central processing unit (CPU) 701, a read-only memory (ROM) 702, a random-access memory (RAM) 703, an auxiliary memory 705, a medium drive 707, a display 708, a network interface (I/F) 709, a keyboard 711, a mouse 712, and a digital versatile disk (DVD) drive 714.

The CPU 701 is a processor that controls the entire operation of the eco-point management system 30. The ROM 702 is a nonvolatile memory that stores a program for the eco-point management system 30. The RAM 703 is a volatile memory used as a work area for the CPU 701.

The auxiliary memory 705 is a memory such as a hard disk drive (HDD) or a solid-state drive (SSD) that stores various data or programs. The medium drive 707 controls the reading and writing of data from and to a storage medium 706 such as a flash memory under the control of the CPU 701.

The display 708 is implemented by, for example, a liquid crystal display (LCD) or an organic electro-luminescence (EL) display, which displays various types of information such as a cursor, a menu, a window, characters, and an image.

The network I/F 709 is an interface circuit that performs data communication with an external device such as the brand owner terminal 10, the consumer terminal 20, and the printing management system 40 via the network N. The network I/F 709 is, for example, a network interface card (NIC) compliant with ETHERNET and can establish wired or wireless communications in compliance with Transmission Control Protocol (TCP)/Internet protocol (IP).

The keyboard 711 is an input device used for inputting operations such as selecting characters, numerals, or various instructions, and for moving a cursor. The mouse 712 is an input device used for inputting operations such as selecting and executing various instructions, selecting an object to be processed, and moving a cursor.

The DVD drive 714 is a device that reads or writes data to or from a DVD 713 such as a DVD-ROM or a digital versatile disk recordable (DVD-R), which is an example of a removable storage medium.

The CPU 701, the ROM 702, the RAM 703, the auxiliary memory 705, the medium drive 707, the display 708, the network I/F 709, the keyboard 711, the mouse 712, and the DVD drive 714 are connected to communicate through a bus line 710 such as an address bus or a data bus.

The hardware configuration of the eco-point management system 30 is not limited to that illustrated in FIG. 4. The eco-point management system 30 does not necessarily include all the components illustrated in FIG. 4 or may include other components. The eco-point management system 30 is not necessarily implemented by a single information processing apparatus as illustrated in FIG. 4 but may be implemented by multiple information processing apparatuses that communicate via a network.

The hardware configuration of the printing management system 40 is similar to the hardware configuration illustrated in FIG. 4.

### Hardware Configuration of Consumer Terminal

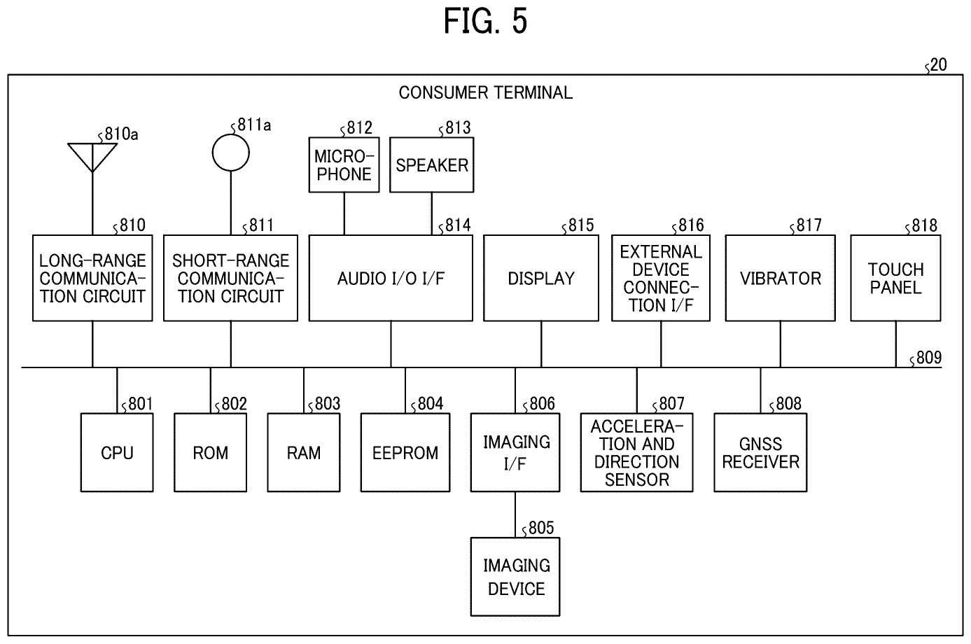

FIG. 5 is a block diagram illustrating a hardware configuration of the consumer terminal 20. The hardware configuration of the consumer terminal 20 is described below with reference to FIG. 5.

As illustrated in FIG. 5, the consumer terminal 20 includes a CPU 801, a ROM 802, a RAM 803, an electrically erasable programmable read-only memory (EEPROM) 804, an imaging device 805, an imaging I/F 806, an acceleration and direction sensor 807, and a global navigation satellite system (GNSS) receiver 808.

The CPU 801 is a processor that controls the entire operation of the consumer terminal 20. The ROM 802 is a non-volatile memory that stores a program, such as an initial program loader (IPL), used for driving the CPU 801. The RAM 803 is a volatile memory used as a work area for the CPU 801. The EEPROM 804 is a non-volatile memory that stores various data such as a control program.

The imaging device 805 is a built-in imaging device (e.g., a camera) that captures an image of a subject to obtain image data under the control of the CPU 801. The imaging device 805 employs an image sensor such as a complementary metal oxide semiconductor (CMOS). In alternative to the CMOS image sensor, an imaging element such as a charge-coupled device (CCD) sensor may be used. The imaging I/F 806, which may be implemented by an interface circuit, is an interface used to control the driving of the imaging device 805.

The acceleration and direction sensor 807 includes various sensors such as an electromagnetic compass to detect geomagnetism, a gyrocompass, and an acceleration sensor.

The GNSS receiver 808 is a receiver that receives positioning signals from positioning satellites. The GNSS receiver 808 receives, for example, a global positioning system (GPS) signal from a GPS satellite.

As illustrated in FIG. 5, the consumer terminal 20 further includes a long-range communication circuit 810, an antenna 810a, a short-range communication circuit 811, an antenna 811a, a microphone 812, a speaker 813, an audio input and output (I/O) I/F 814, a display 815, an external device connection I/F 816, a vibrator 817, and a touch panel 818.

The long-range communication circuit 810 is a communication circuit that performs wireless communication with other devices via the antenna 810a in compliance with a protocol such as Wireless Fidelity (WI-FI) through the network N.

The short-range communication circuit 811 is a communication circuit that performs short-range wireless communication with another device via the antenna 811a in compliance with a communication protocol such as near field communication (NFC) or BLUETOOTH.

The microphone 812 is a built-in sound collecting circuit that converts collected sound into an electrical signal. The speaker 813 is a built-in circuit that converts the electrical signal into physical vibration to output sounds such as music or voice.

The audio I/O I/F 814 is an interface circuit that inputs and outputs audio signals between the microphone 812 and the speaker 813 under the control of the CPU 801. The microphone 812 and the speaker 813 may be parts of a wireless headset.

The display 815 is a display device such as a liquid crystal display or an organic EL display that displays, for example, an image of an object and various icons. The external device connection I/F 816 is an interface circuit that connects to various external devices in compliance with a communication protocol such as the Universal Serial Bus (USB).

The vibrator 817 is a device that generates physical vibration under the control of the CPU 801.

The touch panel 818 is an input device that receives a user's touch operation on the screen of the display 815 to cause the consumer terminal 20 to provide various functions.

The CPU 801, the ROM 802, the RAM 803, the EEPROM 804, the imaging I/F 806, the acceleration and direction sensor 807, the GNSS receiver 808, the long-range communication circuit 810, the short-range communication circuit 811, the audio I/O I/F 814, the display 815, the external device connection I/F 816, the vibrator 817, and the touch panel 818 are connected to communicate with each other via a bus line 809 such as an address bus or a data bus.

Note that the hardware configuration of the consumer terminal 20 illustrated in FIG. 5 is one example. Some of the illustrated components can be omitted, or one or more different devices may be added.

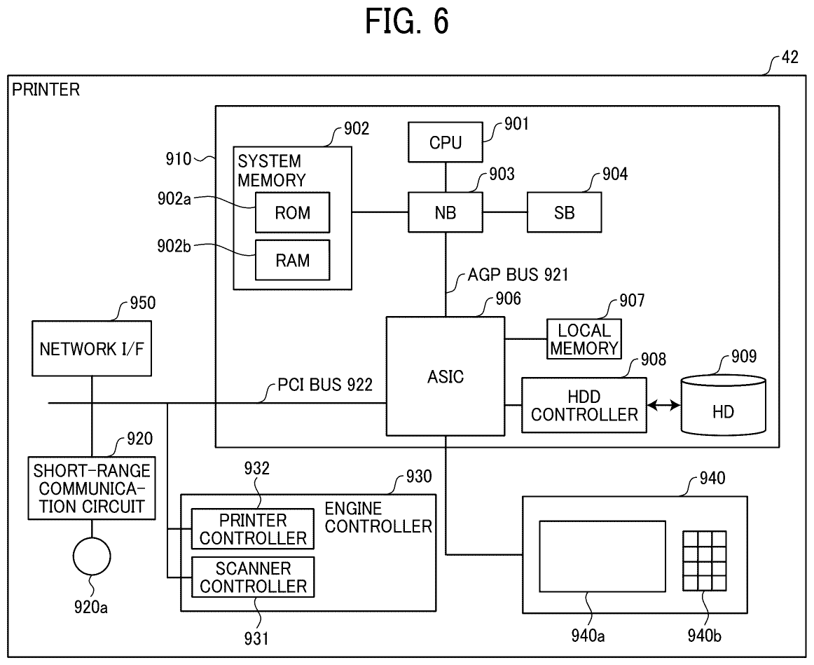

Hardware Configuration of Printer FIG. 6 is a block diagram illustrating a hardware configuration of the printer 42. The hardware configuration of the printer 42 is described below with reference to FIG. 6.

As illustrated in FIG. 6, the printer 42 includes a controller 910, a short-range communication circuit 920, an engine controller 930, a control panel 940, and a network I/F 950.

The controller 910 includes a CPU 901 as a main processor, a system memory 902, a northbridge (NB) 903, a southbridge (SB) 904, an application-specific integrated circuit (ASIC) 906, a local memory 907, a hard disk drive (HDD) controller 908, and a hard disk (HD) 909. The NB 903 and the ASIC 906 are connected by an accelerated graphics port (AGP) bus 921.

The CPU 901 is an arithmetic logic device that controls the entire operation of the printer 42. The NB 903 connects the CPU 901 to the system memory 902, the SB 904, and the AGP bus 921. The NB 903 includes a memory controller that controls the reading or writing of various data from or to the system memory 902, a peripheral component interconnect (PCI) master, and an AGP target.

The system memory 902 includes a ROM 902a that stores programs and data for implementing various functions of the controller 910 and a RAM 902b used as a memory for deploying programs or data or for loading drawing data in printing. The programs stored in the RAM 902b may be stored, as a file installable or executable by the computer, in a computer-readable storage medium, such as a compact disc-read-only memory (CD-ROM), compact disc-recordable (CD-R), or digital versatile disc (DVD).

The SB 904 is a bridge that connects the NB 903 to, for example, a PCI device or a peripheral device. The ASIC 906 is an integrated circuit (IC) for image processing having a hardware element for image processing and acts as a bridge that connects the AGP bus 921, a PCI bus 922, the HDD controller 908, and the local memory 907 to each other. The ASIC 906 includes a PCI target, an AGP master, an arbiter (ARB) as a core element of the ASIC 906, a memory controller that controls the local memory 907, multiple Direct Memory Access Controllers (DMACs) that convert coordinates of image data with a hardware logic, and a PCI unit that transfers data between a scanner controller 931 and a printer controller 932 through the PCI bus 922. The ASIC 906 may be connected to a USB interface or an Institute of Electrical and Electronics Engineers 1394 (IEEE1394) interface.

The local memory 907 is used as a buffer for an image to be copied or a buffer for coding. The HD 909 is a storage for storing image data, font data used in printing, and forms. The HDD controller 908 controls the reading or writing of various data to or from the HD 909 under the control of the CPU 901. The HDD controller 908 and the HD 909 may be replaced by an SSD.

The AGP bus 921 is a bus interface for a graphics accelerator card proposed to accelerate graphics processing. The AGP bus 921 increases the speed of the graphics accelerator card by directly accessing the system memory 902 with high throughput.

The short-range communication circuit 920 is a communication circuit in compliance with a communication protocol such as NFC or BLUETOOTH. The short-range communication circuit 920 is electrically connected to the ASIC 906 through the PCI bus 922. The short-range communication circuit 920 is provided with an antenna 920a for wireless communication.

The engine controller 930 includes the scanner controller 931 and the printer controller 932. The scanner controller 931 and the printer controller 932 each have an image processing function such as error diffusion or gamma conversion.

The control panel 940 includes a panel display 940a such as a touch panel and a hard keypad 940b. The panel display 940a displays current settings or a selection screen to receive a user input. The hard keypad 940b includes a numeric keypad that receives setting values of various image forming parameters such as an image density parameter and a start key that receives an instruction for starting copying.

In response to an instruction to select a specific application input using a mode switch key on the control panel 940, the printer 42 sequentially selects a document server function, a copy function, a print function, and a facsimile communication function. When the document server function is selected, the printer 43 operates in a document server mode. When the copier function is selected, the printer 43 operates in a copy mode. When the printer function is selected, the printer 43 operates in a print mode. When the facsimile communication function is selected, the printer 43 operates in a facsimile communication mode.

The network I/F 950 is an interface circuit that perform data transmission via a network, in compliance with a communication protocol such as ETHERNET or TCP/IP. The network I/F 950 is electrically connected to the ASIC 906 through the PCI bus 922.

The hardware configuration of the printer 42 is not limited to that illustrated in FIG. 6. The printer 42 does not necessarily include all the components illustrated in FIG. 6 or may include other components.

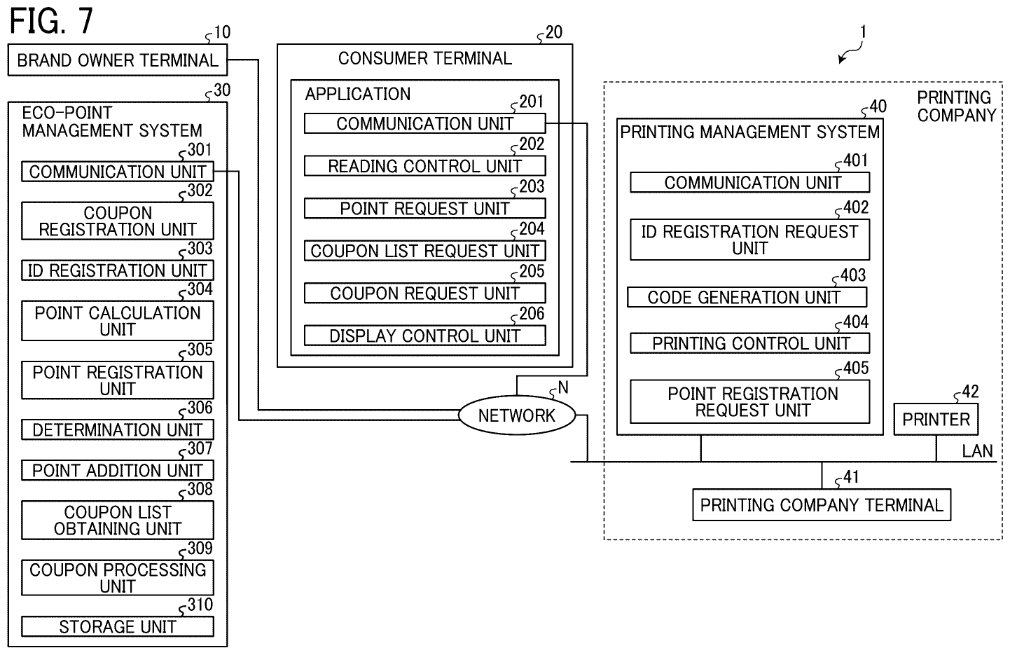

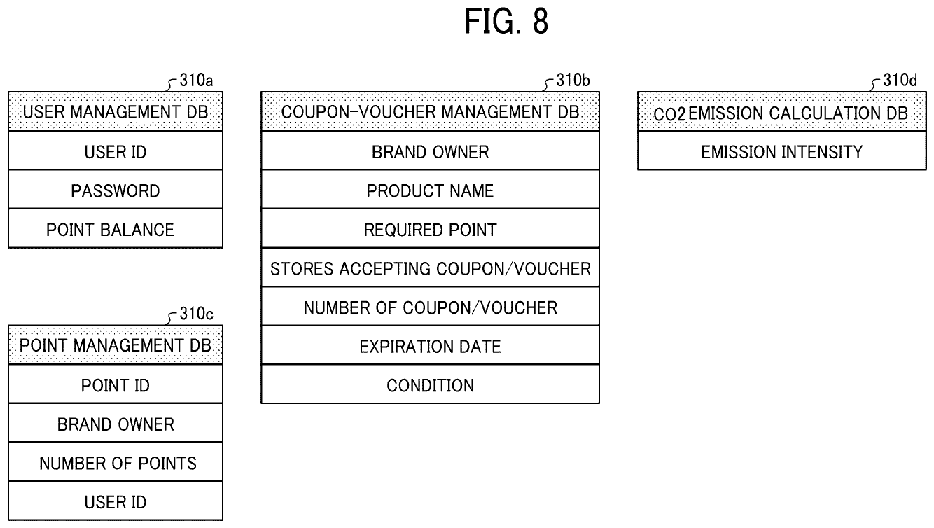

Functional Configuration and Operation of Information Processing System FIG. 7 is a diagram illustrating a functional configuration of the information processing system 1. FIG. 8 is a diagram illustrating a structure of the data processed by the information processing system 1. The functional configuration and the operation of the information processing system 1 are described with reference to FIGS. 7 and 8.

As illustrated in FIG. 7, the consumer terminal 20 includes a communication unit 201, a reading control unit 202, a point request unit 203, a coupon list request unit 204, a coupon request unit 205, and a display control unit 206.

The communication unit 201 is a functional unit that performs data communication with other devices via the long-range communication circuit 810.

The reading control unit 202 is a functional unit that, in response to an operation on the touch panel 818 by the consumer, controls the imaging device 805 to read a QR CODE printed on a printed material (product) and decodes the read QR CODE to obtain a point ID which is identification information of a point.

The point request unit 203 is a functional unit that transmits a request to obtain the points associated with the point ID included in the QR CODE obtained by the reading control unit 202 to the eco-point management system 30 via the communication unit 201.

The coupon list request unit 204 is a functional unit that, in response to an operation on the touch panel 818 by the consumer, transmits a request to obtain a list of coupons available to the consumer to the eco-point management system 30 via the communication unit 201.

The coupon request unit 205 is a functional unit that transmits a request to obtain a coupon selected by the consumer from the list of available coupons to the eco-point management system 30 via the communication unit 201.

The display control unit 206 is a functional unit that controls the display operation performed by the display 815.

The communication unit 201, the reading control unit 202, the point request unit 203, the coupon list request unit 204, the coupon request unit 205, and the display control unit 206 are implemented by the CPU 801 executing an application 200 illustrated in FIG. 5. The functions of the communication unit 201, the reading control unit 202, the point request unit 203, the coupon list request unit 204, the coupon request unit 205, and the display control unit 206 may be partly or entirely implemented by a hardware circuit (integrated circuit) such as a field-programmable gate array (FPGA) or an application specific integrated circuit (ASIC), in alternative to the CPU 801 that executes the software program.

The functionals unit of the consumer terminal 20 illustrated in FIG. 7 are each a conceptual representation of the function, and the functional configuration of the consumer terminal 20 is not limited thereto. For example, the multiple functional units of the consumer terminal 20 illustrated as independent units in FIG. 7 may be configured as a single functional unit. The functions provided by a single functional unit of the consumer terminal 20 illustrated in FIG. 7 may be divided and allocated to multiple functional units. Further, the functional units of the consumer terminal 20 are not necessarily software modules clearly configured as individual blocks as illustrated in FIG. 7, and the functions of the functional units may be implemented as a whole by the execution of the application 200 on the consumer terminal 20.

As illustrated in FIG. 7, the eco-point management system 30 includes a communication unit 301 (a reception unit), a coupon registration unit 302 (a third registration unit), an ID registration unit 303 (a first registration unit), a point calculation unit 304 (calculation unit), a point registration unit 305 (second registration unit), a determination unit 306, a point addition unit 307 (addition unit), a coupon list obtaining unit 308, a coupon processing unit 309 (processing unit), and a storage unit 310.

The communication unit 301 is a functional unit that performs data transmission with other devices via the network I/F 709.

The coupon registration unit 302 is a functional unit that, when the communication unit 301 receives a registration request to register a coupon from the brand owner terminals 10, registers information on the coupon in the coupon-voucher management DB 310b in the storage unit 310. The coupon-voucher management DB 310b (second association information) is a database in, for example, a table format for managing pieces of information relating to a coupon in association with each other. As illustrated in FIG. 8, the coupon-voucher management DB 310b stores the information (e.g., identification information) on the brand owner (third identification information), the name of the product to which the coupon is applied, the number of points for obtaining the coupon, the store where the coupon is usable, the number of issued coupons, the expiration date of the coupon, and conditions for obtaining the coupon.

The ID registration unit 303 is a functional unit that, when the communication unit 301 receives a registration request for a point ID from the printing management system 40, newly issues a point ID and registers the point ID in the point management DB 310c (first association information) in the storage unit 310. The point management DB 310c is a database in, for example, a table format for managing pieces of information relating to a point in association with each other. As illustrated in FIG. 8, the point management DB 310c stores the point ID, the brand owner who provides the product assigned with the points associated with the point ID, the number of points associated with the point ID, and the consumer ID (second identification information) identifying the consumer who have earned the point. The consumer ID may be referred to as a user ID in the following description. The ID registration unit 303 first registers the point ID and the brand owner corresponding to the point ID in association with each other when registering the point ID in the point management DB 310c.

When the point calculation unit 304 is a functional unit that, when the communication unit 301 receives from the printing management system 40 a registration request for a point, calculates a predicted value and an actual value of carbon dioxide emission from the amount of printing activity received together with the registration request for the point and the emission intensity indicating the carbon dioxide emission per unit of activity amount, stored in the CO2 emission calculation DB 310d, calculates the number of points from the predicted value and the actual value, and registers the calculated number of points in the coupon-voucher management DB 310b.

For example, the point calculation unit 304 obtains the predicted value of carbon dioxide emission using a learned model that calculates a predicted value of the carbon dioxide emission from the amount of activity of printing, and calculates the actual carbon dioxide emission from the product of the amount of printing activity and the emission intensity obtained from the CO2 emission calculation DB 310d. Then, the point calculation unit 304 calculates the number of points by Equation 1 below.

$$Point = Predicted CO 2 emission - Actual CO 2 emission amount \qquad ( 1 )$$

In other words, the smaller the actual value compared with the predicted value (the larger the carbon dioxide reduction), the greater the number of points calculated. The CO2 emission calculation DB 310d is a database for managing information such as the emission intensity of the activity amount as illustrated in FIG. 8. The information stored in the CO2 emission calculation DB 310d is used to calculate carbon dioxide emission.

Alternative to calculating the number of points using the above Equation 1, the point calculation unit 304 may calculate the number of points by multiplying the value of Equation 1 by a coefficient. Yet alternatively, the point calculation unit 304 may calculate the number of points by adding a numerical value indicating, for example, the number of log-in days in a campaign period to the right side of Equation 1, or may add some point to the right side of Equation 1 to encourage the consumer to purchase the product as a limited-time promotion. The point calculation unit 304 may change the above-described point calculation method for, for example, on an individual industry basis or an individual manufacturer basis.

The point registration unit 305 is a functional unit that registers the number of points calculated by the point calculation unit 304 in association with the point ID registered in the point management DB 310c by the ID registration unit 303.

The determination unit 306 is a functional unit that, when the communication unit 301 receives the point request from the consumer terminal 20, determines whether one or more points associated with the point ID received together with the point request has already been given. To be specific, the determination unit 306 refers to the point management DB 310c and determines whether the point has already been given depending on whether a user ID associated with the point ID has already been registered. That is, when the user ID associated with the point ID is already registered, the determination unit 306 determines that the point associated with the point ID has already been given.

The point addition unit 307 is a functional unit that, when the determination unit 306 determines that the point associated with the point ID is not an already-given point, refers to a user management DB 310a in the storage unit 310 and adds the point associated with the point ID to the point balance associated with to the user ID identifying the consumer who uses the consumer terminal 20 that has transmitted the point request received by the communication unit 301. The user management DB 310a (management information) is a database in, for example, the table format for managing the user ID, a password for login, and the point balance indicating the points earned by the users in association with each other as illustrated in FIG. 8.

The coupon list obtaining unit 308 is a functional unit that, when the communication unit 301 receives a request to obtain a list of coupons from the consumer terminal 20, refers to the coupon-voucher management DB 310b and obtains a list of coupons available to the consumer who uses the consumer terminal 20. For example, the coupon list obtaining unit 308 obtains a list of coupons that satisfy the expiration date or the conditions among the coupons registered in the coupon-voucher management DB 310b.

The coupon processing unit 309 is a functional unit that, when the communication unit 301 receives a request to obtain a coupon selected by a consumer from the consumer terminal 20, refers to the user management DB 310a and sets the coupon to be a possessed coupon by the consumer when the number of points for obtaining the coupon is equal to or less than the number of points possessed by the consumer.

The storage unit 310 is a functional unit that stores the user management DB 310a, the coupon-voucher management DB 310b, the point management DB 310c, the CO2 emission calculation DB 310d illustrated in FIG. 8, etc. The storage unit 310 is implemented by the auxiliary memory 705 illustrated in FIG. 4.

The communication unit 301, the coupon registration unit 302, the ID registration unit 303, the point calculation unit 304, the point registration unit 305, the determination unit 306, the point addition unit 307, the coupon list obtaining unit 308, and the coupon processing unit 309 are implemented by the CPU 701 illustrated in FIG. 4 executing a program. A part or all of the communication unit 301, the coupon registration unit 302, the ID registration unit 303, the point calculation unit 304, the point registration unit 305, the determination unit 306, the point addition unit 307, the coupon list obtaining unit 308, and the coupon processing unit 309 may be implemented by a hardware circuit (integrated circuit) such as an FPGA or an ASIC instead of the CPU 701 executing the software program.

The functional units of the eco-point management system 30 illustrated in FIG. 7 are conceptual representations of the functions and may be implemented in various other ways. For example, the multiple functional units of the eco-point management system 30 illustrated as independent functional units in FIG. 7 may be configured as a single functional unit. Alternatively, the function of one functional unit of the eco-point management system 30 illustrated in FIG. 7 may be divided into multiple functions and allocated to multiple functional units. Further, the functional units of the eco-point management system 30 are not necessarily software modules clearly configured as individual blocks as illustrated in FIG. 7, and the functions of the functional units may be implemented as a whole by the execution of a program on the eco-point management system 30.

As illustrated in FIG. 7, the printing management system 40 includes a communication unit 401, an ID registration request unit 402, a code generation unit 403, a printing control unit 404, and a point registration request unit 405.

The communication unit 401 is a functional unit that performs data transmission with other devices via the network I/F 709.

The ID registration request unit 402 is a functional unit that, when the communication unit 401 receives a job execution command for printing from the printing company terminal 41, transmits a point ID registration request for the point corresponding to the printed material created in the job to the eco-point management system 30 via the communication unit 401.

The code generation unit 403 is a functional unit that, when the communication unit 401 receives the point ID from the eco-point management system 30, generates a QR CODE including the information on the point ID. The QR CODE may include, for example, a uniform resource locator (URL) for accessing the eco-point management system 30 when the QR CODE is read.

The printing control unit 404 is a functional unit that controls the operation of the printer 42. For example, the printing control unit 404 prints the QR CODE generated by the code generation unit 403 on a printed material (product).

The point registration request unit 405 is a functional unit that calculates the activity amount of the job instructed by the job execution command received by the communication unit 401 and transmits a point registration request in addition to the activity amount to the eco-point management system 30 via the communication unit 401.

The communication unit 401, the ID registration request unit 402, the code generation unit 403, the printing control unit 404, and the point registration request unit 405 are implemented by the CPU 701 illustrated in FIG. 4 executing a program. The functions of the communication unit 401, the ID registration request unit 402, the code generation unit 403, the printing control unit 404, and the point registration request unit 405 may be partly or entirely implemented by a hardware circuit (integrated circuit) such as an FPGA or an ASIC instead of the CPU 701 executing the software program.

The functional units of the printing management system 40 illustrated in FIG. 7 are conceptual representations of the functions, and the functional configuration thereof is not limited thereto. For example, the multiple functional units of the printing management system 40 illustrated as independent functional units in FIG. 7 may be configured as one functional unit. Alternatively, the function performed by one functional unit of the printing management system 40 illustrated in FIG. 7 may be divided and allocated to multiple functional units. Further, the functional units of the printing management system 40 are not necessarily software modules clearly configured as individual blocks as illustrated in FIG. 7 and the functions of the functional units may be implemented as a whole by the execution of a program on the printing management system 40.

### Point Registration Process by Information Processing System

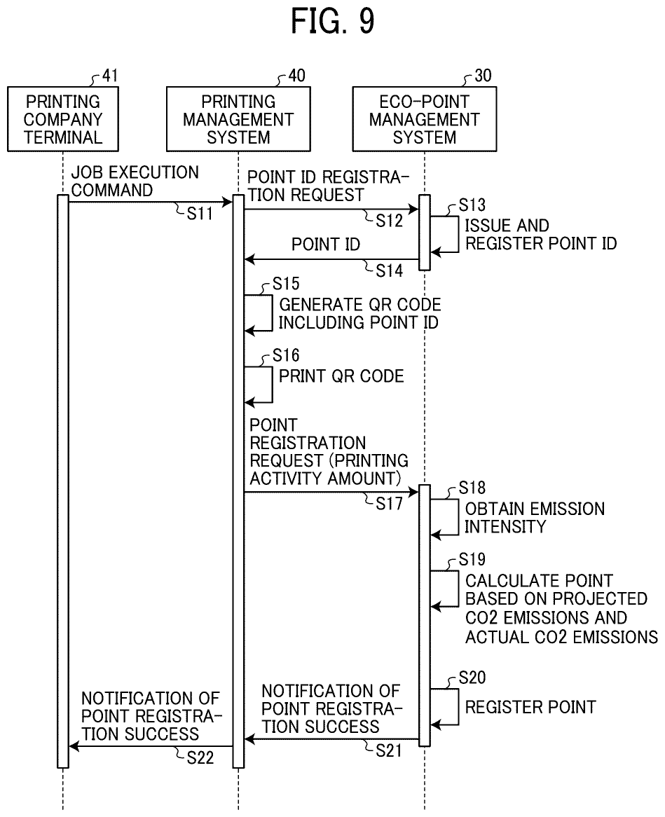

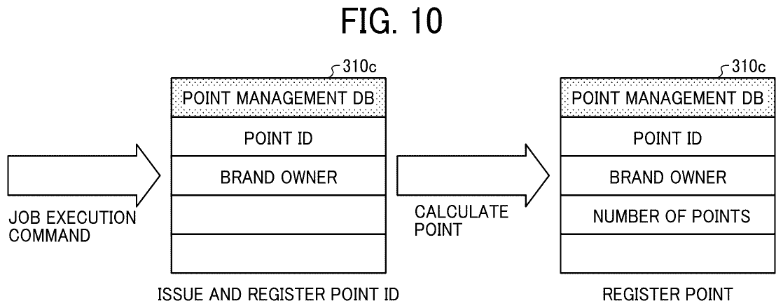

FIG. 9 is a sequence chart of a point registration process performed by the information processing system 1. FIG. 10 is a diagram illustrating changes in the point management DB 310c in the point registration process performed by the information processing system 1. The point registration process performed by the information processing system 1 is described with reference to FIGS. 9 and 10.

### Step S11

The printing company terminal 41 transmits a job execution command instructing printing to create a desired product to the printing management system 40 in response to an operation by printing company staff. The communication unit 401 of the printing management system 40 receives the job execution command.

### Step S12

When the communication unit 401 receives the job execution command for printing from the printing company terminal 41, the ID registration request unit 402 of the printing management system 40 transmits a point ID registration request for the point corresponding to the printed material created in the job to the eco-point management system 30 via the communication unit 401. The communication unit 301 of the eco-point management system 30 receives the point ID registration request.

### Step S13

When the communication unit 301 receives the point ID registration request from the printing management system 40, the ID registration unit 303 of the eco-point management system 30 newly issues a point ID and registers the point ID in the point management DB 310c in the storage unit 310. The issued point ID is a unique ID that does not overlap with already issued point IDs. When the ID registration unit 303 registers the point ID in the point management DB 310c, the brand owner corresponding to the point ID is associated with the point ID as illustrated in FIG. 10.

### Step S14

The ID registration unit 303 transmits the issued point ID to the printing management system 40 via the communication unit 301. The communication unit 401 of the printing management system 40 receives the point ID.

### Step S15

When the communication unit 401 receives the point ID from the eco-point management system 30, the code generation unit 403 of the printing management system 40 generates a two-dimensional code (e.g., QR CODE or PDF417) including the information on the point ID.

### Step S16

The printing control unit 404 of the printing management system 40 prints the QR CODE generated by the code generation unit 403 on a printed material (product).

### Step S17

The point registration request unit 405 of the printing management system 40 calculates the activity amount of the job instructed by the job execution command received by the communication unit 401, and transmits the activity amount and the point registration request to the eco-point management system 30 via the communication unit 401. Then, the communication unit 301 of the eco-point management system 30 receives the activity amount and the point registration request.

### Step S18

When the communication unit 301 receives the activity amount and the point registration request from the printing management system 40, the point calculation unit 304 of the eco-point management system 30 obtains the emission intensity from the CO2 emission calculation DB 310d.

### Step S19

The point calculation unit 304 calculates the predicted value and the actual value of carbon dioxide emission from the activity amount and the emission intensity, calculates the points from the above-described Equation 1, and registers the points in the coupon-voucher management DB 310b.

Alternative to calculating the points using the above Equation 1, the point calculation unit 304 may calculate the points by multiplying the value of Equation 1 by a coefficient. Yet alternatively, the point calculation unit 304 may calculate the points by adding a numerical value indicating, for example, the number of log-in days in a campaign period to the right side of Equation 1, or may add some points to the right side of Equation 1 to encourage the consumer to purchase the product as a limited-time promotion. The point calculation unit 304 may change the above-described point calculation method for, for example, on an individual industry basis or an individual manufacturer basis.

### Step S20

As illustrated in FIG. 10, the point registration unit 305 of the eco-point management system 30 registers the number of points calculated by the point calculation unit 304 in association with the point ID registered in the point management DB 310c by the ID registration unit 303.

### Step S21

The point registration unit 305 transmits a notification indicating that the point registration has succeeded to the printing management system 40 via the communication unit 301. Then, the communication unit 401 of the printing management system 40 receives the notification indicating that the point registration has succeeded.

### Step S22

The communication unit 401 of the printing management system 40 transmits the notification indicating that the point registration has succeeded, which is received from the eco-point management system 30, to the printing company terminal 41. The printing company terminal 41 displays information that the point registration has succeeded. Then, the point registration process ends.

In the point registration process illustrated in FIG. 9, the points are calculated and registered after the QR CODE is printed, but the sequence is not limited thereto. Alternatively, the points may be calculated and registered after the printed material is created, and the QR CODE may be printed on the printed material after the points are determined.

### Process of Obtaining Point by Information Processing System

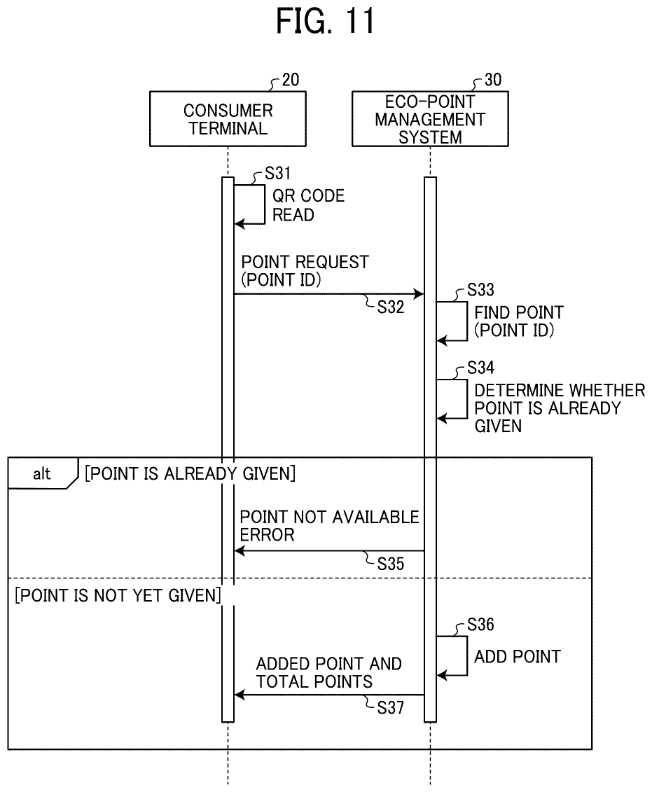

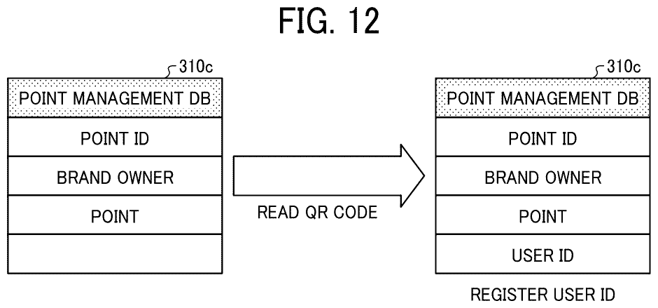

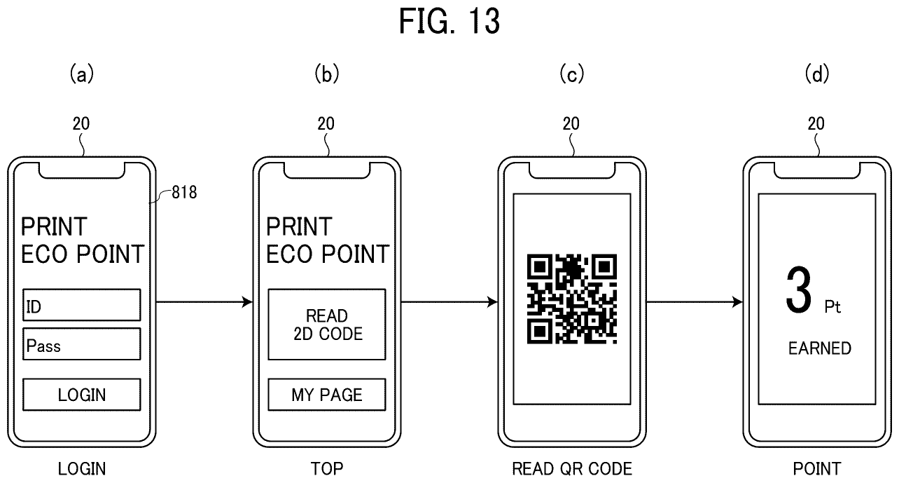

FIG. 11 is a flowchart of the point obtaining process performed by the information processing system 1. FIG. 12 is a diagram illustrating changes in the point management DB 310c in the point obtaining process performed by the information processing system 1. FIG. 13 is a diagram illustrating changes in the screen display on the consumer terminal 20 in the point obtaining process performed by the information processing system 1. The point obtaining process performed by the information processing system 1 is described with reference to FIGS. 11 to 13.

### Step S31

In response to an operation on the touch panel 818 by the consumer, the reading control unit 202 of the consumer terminal 20 controls the imaging device 805 to read the two-dimensional code (e.g., QR CODE or PDF417) printed on the printed material (product), and decodes the QR CODE to obtain the point ID identifying the point. For example, the consumer performs a login operation on the screen of the consumer terminal 20 illustrated in (a) of FIG. 13, and taps the button for reading a two-dimensional 2D code (e.g., QR CODE) on the top screen illustrated in (b) of FIG. 13.

When the QR CODE is read by the reading control unit 202, the display control unit 206 displays the read QR CODE on the display 815 as illustrated in (c) of FIG. 13.

### Step S32

The point request unit 203 of the consumer terminal 20 transmits a point request to obtain the point associated with the point ID included in the QR CODE obtained by the reading control unit 202 to the eco-point management system 30 via the communication unit 201. The communication unit 301 of the eco-point management system 30 receives the point request and the point ID.

### Step S33

When the communication unit 301 receives the point request from the consumer terminal 20, the determination unit 306 of the eco-point management system 30 refers to the point management DB 310c and obtains (retrieves) the number of points associated with the point ID received together with the point request.

### Step S34

The determination unit 306 refers to the point management DB 310c and determines whether the obtained point has already been given depending on whether a user ID is registered in association with the point ID received together with the point request. When the point has already been given, the process proceeds to step S35. When the point has not been given, the process proceeds to step S36.

### Step S35

When the determination unit 306 determines that the point has already been given, the determination unit transmits a point error indicating that the point has already been given, to the consumer terminal 20 via the communication unit 301. The communication unit 201 of the consumer terminal 20 receives the point error. The display control unit 206 of the consumer terminal 20 displays the point error received by the communication unit 201 on the display 815. In this case, the consumer has failed to earn the point. Then, the point obtaining process ends.

### Step S36

When the determination unit 306 determines that the point associated with the point ID is not an already-given point, the point addition unit 307 of the eco-point management system 30 refers to the user management DB 310a, and adds the point associated with the point ID to the point balance associated with the user ID of the consumer who uses the consumer terminal 20 that has transmitted the point request to the communication unit 301. Thus, the point addition unit 307 updates the point balance.

### Step S37

The point addition unit 307 notifies the added points and the result of addition of points (updated point balance) to the consumer terminal 20 via the communication unit 301. The communication unit 201 of the consumer terminal 20 receives the added points and updated point balance. Further, the point addition unit 307 registers the user ID of the consumer who uses the consumer terminal 20 in association with the point ID received by the communication unit 301 in the point management DB 310c as illustrated in FIG. 12. This indicates that the point associated with the point ID has been given, and unauthorized use such as double reading of the QR CODE is prevented. The information indicating that the point has been given is not limited to a user ID, but, for example, flag information indicating that the point has been given may be registered.

Then, the display control unit 206 of the consumer terminal 20 displays the added points received by the communication unit 201 and the updated point balance on the display 815. In this case, the consumer has successfully earned the point. FIG. 13 (d) illustrates an example of the display of the earned points on the display 815 of the consumer terminal 20. The total number of points (updated point balance) may be displayed on the display 815. Then, the point obtaining process ends.

This process is expected to encourage consumers to purchase the goods of the brand owner to earn more points and encourage the printing company to make efforts to reduce carbon dioxide emission to be assigned with higher points and selected as the partner from the brand owner.

### Coupon Exchange Process by Information Processing System

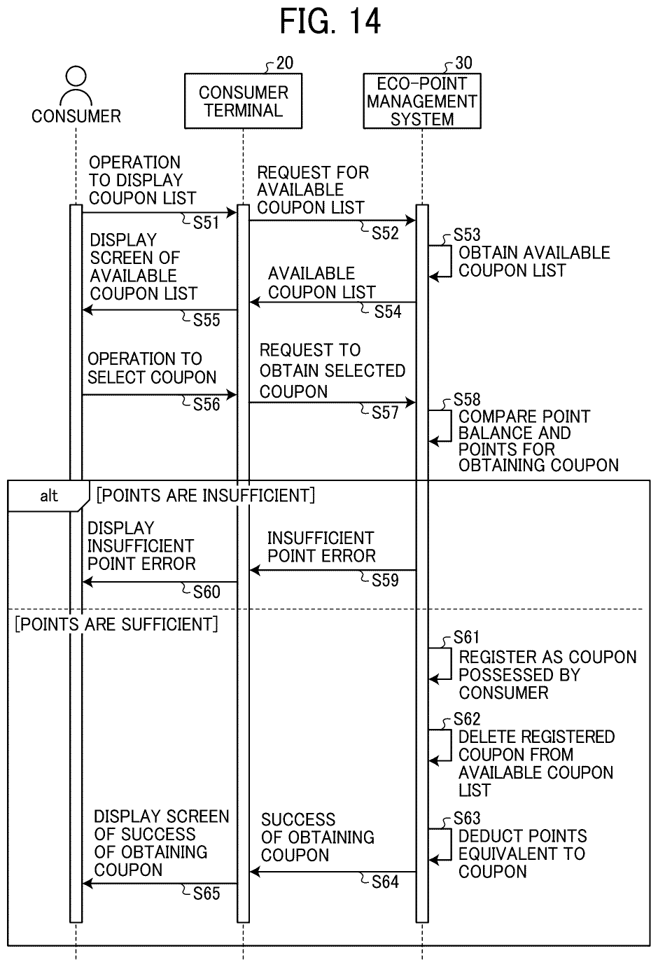

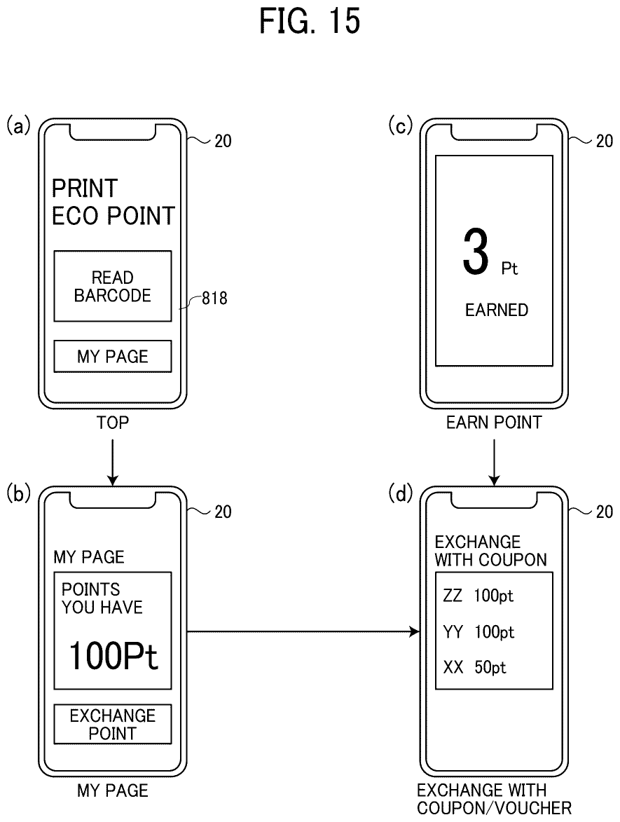

FIG. 14 is a flowchart of a coupon exchange process performed by the information processing system 1. FIG. 15 is a diagram illustrating changes in the screen display of the consumer terminal 20 in the coupon exchange process performed by the information processing system 1. The coupon exchange process performed by the information processing system 1 is described with reference to FIGS. 14 and 15.

### Step S51

The consumer performs an operation to display a list of coupons available to the consumer on the touch panel 818 of the consumer terminal 20 to exchange the points earned by the consumer with a coupon. For example, the consumer displays a “my page” screen illustrated in (b) of FIG. 15 from the top screen of the consumer terminal 20 illustrated in (a) of FIG. 15, and presses the “exchange point” button.

### Step S52

The coupon list request unit 204 of the consumer terminal 20 transmits a request for the list of coupons available to the consumer to the eco-point management system 30 via the communication unit 201 in response to the operation on the touch panel 818 by the consumer. Then, the communication unit 301 of the eco-point management system 30 receives the request for the list of available coupons.

### Step S53

When the communication unit 301 receives the request for the list of coupons from the consumer terminal 20, the coupon list obtaining unit 308 of the eco-point management system 30 refers to the coupon-voucher management DB 310b and obtains the list of coupons available to the consumer using the consumer terminal 20. For example, the coupon list obtaining unit 308 obtains a list of coupons that satisfies the expiration date or the condition among the coupons registered in the coupon-voucher management DB 310b.

### Step S54

The coupon list obtaining unit 308 transmits the obtained list of available coupons to the consumer terminal 20 via the communication unit 301. Then, the communication unit 201 of the consumer terminal 20 receives the list of available coupons.

### Step S55

The display control unit 206 of the consumer terminal 20 displays the list of available coupons received by the communication unit 201 on the display 815. For example, the display control unit 206 controls the display 815 to display the list of the available coupons as illustrated in (d) of FIG. 15. Alternatively, the screen illustrated in (c) of FIG. 15 displaying the points earned by reading the QR CODE may be transitioned to the screen illustrated in (d) of FIG. 15 displaying the list of coupons.

### Step S56

The consumer performs an operation on the touch panel 818 to select a coupon that the consumer desires to exchange with the earned points from the list of available coupons displayed on the display 815 of the consumer terminal 20.

### Step S57

The coupon request unit 205 of the consumer terminal 20 transmits a request to obtain the coupon selected by the consumer from the list of available coupons to the eco-point management system 30 via the communication unit 201. Then, the communication unit 301 of the eco-point management system 30 receives the request to obtain the coupon.

### Step S58

When the communication unit 301 receives the request for obtaining the coupon selected by the consumer from the consumer terminal 20, the coupon processing unit 309 of the eco-point management system 30 compares the number of points for obtaining the coupon specified by the request with the point balance of the consumer recorded in the user management DB 310a. When the number of points for obtaining the coupon is greater than the point balance of the consumer (the possessed points are insufficient), the process proceeds to step S59. When the number of points is equal to or less than the points possessed by the consumer (the possessed points are sufficient), the process proceeds to step S61.

### Step S59

When the number points for obtaining the coupon is larger than the number of points possessed by the consumer, the coupon processing unit 309 transmits an error indicating point insufficiency to the consumer terminal 20 via the communication unit 301. Then, the communication unit 201 of the consumer terminal 20 receives the error indicating point insufficiency.

### Step S60

The display control unit 206 of the consumer terminal 20 controls the display 815 to display the error indicating point insufficiency received by the consumer terminal 20. Then, the coupon exchange process ends.

### Step S61

When the number of points for obtaining the coupon is equal to or less than the points possessed by the consumer, the coupon processing unit 309 sets the coupon to be a possessed coupon by the consumer.

### Step S62

The coupon processing unit 309 deletes the coupon processed by the consumer from the list of the available coupons obtained by the coupon list obtaining unit 308.

### Step S63

The coupon processing unit 309 refers to the user management DB 310a and subtracts the number of points equivalent to the coupon from the point balance of the consumer.

### Step S64

The coupon processing unit 309 transmits information indicating the success of obtaining the coupon to the consumer terminal 20 via the communication unit 301. Then, the communication unit 201 of the consumer terminal 20 receives the information indicating the success of obtaining the coupon.

### Step S65

The display control unit 206 displays, on the display 815, the information indicating the success of obtaining the coupon received by the consumer terminal 20. Then, the coupon exchange process ends.

As described above, in the eco-point management system 30, the ID registration unit 303 issues a point ID identifying the points with which a consumer obtains a coupon and registers the point ID in the point management DB 310c. The point calculation unit 304 calculates the actual carbon dioxide emission from the activity amount of the printed material on which the QR CODE including the point ID is printed and calculates the number of points based on the actual carbon dioxide emission. The point registration unit 305 registers the number of points calculated by the point calculation unit 304 in the point management DB 310c in association with the point ID. Even if the printing company makes efforts to reduce carbon dioxide emission in creating printed materials, the printing company is not motivated to be environmentally conscious unless brand owners aware the reduction result. In view of this, the eco-point management system 30 allows the brand owner to recognize that the printed material has created in an environmentally conscious manner, and the environmental awareness of the printing company increases.

In the description above, when at least one of the functional units of the information processing system 1 is implemented by a program executed by the CPU, the program may be preinstalled in a ROM or any desired memory of the information processing system 1. Further, the program executed by the devices included in the information processing system 1 may be stored, as a file installable to or executable by a computer, in a computer-readable recording medium, such as a CD-ROM, a flexible disk (FD), a CD-R, or a DVD. Further, the program executed by the information processing system 1 may be stored on a computer connected to a network such as the Internet, to be downloaded via the network. Further, the computer program executed in the information processing system 1 may be provided or distributed as a web application via a network such as the Internet. The program executed by the information processing system 1 has a module configuration including at least one of the above-described functional units. As the hardware, when the CPU reads the program from the memory and executes the program, the above-described functional units are loaded onto the main memory (work area) to operate as the functional units.

### Aspects of the Present Disclosure are as Follows.

In a first aspect, a point management system that manages a point for a consumer to obtain a coupon includes a first registration unit to issue first identification information identifying the point and register the first identification information in first association information (e.g., a point management DB), a calculation unit to calculate an actual value of a carbon dioxide emission from an amount of activity for a printed material bearing a symbol including the first identification information, calculate the number of points based on the actual value, and a second registration unit to register the number of points calculated by the calculation unit in the first association information in association with the first identification information.

In a second aspect, in the point management system according to the first aspect, the first registration unit issues the first identification information when a job to create the printed material is generated in a printing management system of a printing company, and the point management system further includes a reception unit to receive the amount of activity for the printed material created in the job. The calculation unit calculates the actual value from the amount of activity received by the reception unit.

In a third aspect, in the point management system according to the first or second aspect, the calculation unit obtains a predicted value of the carbon dioxide emission using a learned model that predicts the carbon dioxide emission from the amount of activity for the printed material, and calculates the number of points based on the predicted value and the actual value.

In a fourth aspect, in the point management system according to the second aspect, the reception unit further receives the first identification information included in the symbol read by a first information processing terminal used by the consumer, and the point management system further includes a determination unit to determine whether the first association information indicates that the point associated with the first identification information received by the reception unit has already been given.

In a fifth aspect, the point management system according to the fourth aspect further includes an addition unit. When the determination unit determines that the point has not yet been given, the addition unit add the point to the point balance of the consumer in management information for managing the point balance of the consumer, and register the point and second identification information (e.g., consumer ID) identifying the consumer in the first association information in association with each other.

In a sixth aspect, in the point management system according to the fifth aspect, the determination unit determines that the point has been given when the second identification information associated with the point is registered in the first association information.

In a seventh aspect, the point management system according to the second aspect further includes a third registration unit that, in response to a request from a second information processing terminal used by a provider who provides the printed material, registers third identification information identifying the provider, the number of points for obtaining the coupon, and the name of a product to which the coupon is applicable in association with each other in second association information (e.g., a coupon-voucher management DB).

In an eighth aspect, in the point management system according to the seventh aspect, the reception unit receives a coupon obtaining request from a first information processing terminal used by the consumer, and the point management system further includes a processing unit. The processing unit obtains the point balance of the consumer from management information for managing the point balance of the consumer, obtains, from the second association information (e.g., a coupon-voucher management DB), to the number of points associated with the coupon requested by the obtaining request received by the reception unit, and compares the point balance with the number of points. When the number of points is equal to or less than the point balance of the consumer, the processing unit sets the coupon to be a possessed coupon by the consumer.

In a ninth aspect, in the point management system according to any one of the first aspect to the eighth aspect, the symbol is a QR CODE.

In a tenth aspect, a point management method for managing points for a consumer to obtain a coupon includes registering first identification information identifying the point in first association information, calculating an actual value of a carbon dioxide emission from an amount of activity for creating a printed material bearing a symbol including the first identification information, calculating the number of points based on the actual value, and registering the points calculated by the calculation unit in the first association information in association with the first identification information.

In an eleventh aspect, a non-transitory recording medium carries computer readable codes for controlling a computer system to perform a method for managing points for a consumer to obtain a coupon.

The method includes registering first identification information identifying the point in first association information, calculating an actual value of a carbon dioxide emission from an amount of activity for creating a printed material bearing a symbol including the first identification information, calculating the number of points based on the actual value, and registering the points calculated by the calculation unit in the first association information in association with the first identification information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A point management system comprising circuitry configured to:
issue first identification information identifying a point for a consumer to obtain a coupon;
register the first identification information in first association information;
calculate an actual value of a carbon dioxide emission from an amount of activity for a printed material, the printed material bearing a symbol including the first identification information;
calculate a number of points based on the actual value; and
register the calculated number of points in the first association information in association with the first identification information.

2. The point management system according to claim 1, wherein the circuitry is configured to:
issue the first identification information in response to a registration request for the first identification information, the registration request being transmitted from a printing management system of a provider of the printed material when the printing management system generates a job to create the printed material; and
receive the amount of activity for the printed material in the job from the printing management system.

3. The point management system according to claim 1, wherein the circuitry is configured to:
obtain a predicted value of the carbon dioxide emission using a learned model that predicts the predicted value from the amount of activity for the printed material; and
calculate the number of points based on the predicted value and the actual value.

4. The point management system according to claim 2, wherein the circuitry is configured to:
receive the first identification information included in the symbol read by a first information processing terminal used by the consumer; and
determine whether the first association information indicates that one or more points associated with the received first identification information have already been given.

5. The point management system according to claim 4, wherein the circuitry is further configured to:
add the one or more points to a point balance of the consumer in management information when determining that the one or more points have not yet been given, the management information recording the point balance of the consumer; and
register the one or more points not yet given and second identification information identifying the consumer in the first association information in association with each other.

6. The point management system according to claim 5, wherein the circuitry is configured to:
determine that the one or more points have already been given when the second identification information associated with the one or more points is registered in the first association information.

7. The point management system according to claim 2, wherein the circuitry is configured to:
in response to a request from a second information processing terminal used by a provider of the printed material, register third identification information identifying the provider, a number of points for obtaining the coupon, and a name of a product to which the coupon is applicable in association with each other in second association information.

8. The point management system according to claim 7, wherein the circuitry is configured to:
receive a coupon obtaining request from a first information processing terminal used by the consumer;
obtain a point balance of the consumer from management information recording the point balance of the consumer;
obtain a number of points associated with the coupon requested by the coupon obtaining request from the second association information;
compare the point balance with the number of points; and
set the coupon as being possessed by the consumer when the number of points is equal to or less than the point balance of the consumer.

9. The point management system according to claim 1, wherein the symbol is a QR CODE.

10. A point management method comprising:
issuing first identification information identifying a point for a consumer to obtain a coupon;
registering the first identification information in first association information;
calculating an actual value of a carbon dioxide emission from an amount of activity for a printed material, the printed material bearing a symbol including the first identification information;
calculating a number of points based on the actual value; and
registering the calculated number of points in the first association information in association with the first identification information.

11. A non-transitory recording medium storing a plurality of program codes which, when executed by one or more processors, causes the one or more processors to perform a method, the method comprising:
issuing first identification information identifying a point for a consumer to obtain a coupon;
registering the first identification information in first association information;
calculating an actual value of a carbon dioxide emission from an amount of activity for a printed material, the printed material bearing a symbol including the first identification information;
calculating a number of points based on the actual value; and
registering the calculated number of points in the first association information in association with the first identification information.
